(19) United States
(12) Patent Application Publication
(10) Pub. No.: US 2016/0301241 A1
(43) Pub. Date: Oct. 13, 2016

(54) WIRELESS POWER RECEIVER AND POWER SUPPLY APPARATUS USING THE SAME

(71) Applicant: SAMSUNG ELECTRO-MECHANICS CO., LTD., Suwon-si (KR)

(72) Inventors: Sang Ho CHO, Suwon-si (KR); Chang Ik KIM, Suwon-si (KR); Seung Won PARK, Suwon-si (KR); Tae Sung KIM, Suwon-si (KR); Eun Young SHIN, Suwon-si (KR); Jae Suk SUNG, Suwon-si (KR)

(73) Assignee: SAMSUNG ELECTRO-MECHANICS CO., LTD., Suwon-si (KR)

(21) Appl. No.: 15/072,967

(22) Filed: Mar. 17, 2016

(30) Foreign Application Priority Data
Apr. 9, 2015 (KR) 10-2015-0050416
Sep. 25, 2015 (KR) 10-2015-0136999

(51) Int. Cl. H02J 7/02; H02J 50/12

(52) U.S. Cl. CPC H02J 7/025; H02J 50/12

(57) ABSTRACT

A wireless power receiver in a wearable device includes a receiving coil wound around an internal part and a power circuit configured to receive power from the receiving coil and provide the power to the wearable device.

### CROSS-REFERENCE TO RELATED APPLICATION(S)

This application claims the benefit under 35 U.S.C. §119(a) of Korean Patent Application No. 10-2015-0050416 filed on Apr. 9, 2015 and Korean Patent Application No. 10-2015-0136999, filed on Sep. 25, 2015 in the Korean Intellectual Property Office, the disclosures of which are incorporated herein by reference for all purposes.

### BACKGROUND

1. Field

The present disclosure relates to a wireless power receiver and a power supply apparatus using the same.

2. Description of Related Art

In accordance with the development of wireless technology, non-contact wireless power charging technology capable of charging an electronic device even in a non-contact state has recently been developed.

However, wireless power transmitting technology according to the related art has a number of limiting requirements in order to smoothly perform the charging. That is, upon wirelessly transmitting and receiving the power, there are limits on a transmission distance, a position relationship between a transceiver, and the like.

That is, there is a problem in that efficiency of wireless power charging may be increased only in a case in which a wireless power receiver and a wireless power transmitter are positioned to be opposite each other.

Meanwhile, wireless power charging technology tends to be applied to various portable devices. Therefore, there has been demand for wireless power charging technology capable of efficiently performing the charging even in various device environments.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to a general aspect, a wireless power receiver in a wearable device, the wireless power receiver includes a receiving coil wound around an internal part; and a power circuit configured to receive power from the receiving coil and provide the power to the wearable device.

The receiving coil may be wound in a length direction around the internal part.

The wireless power receiver may further include a magnetic sheet attached to a surface of the internal part, wherein a portion of the receiving coil is wound around an outer surface of the magnetic sheet.

The wireless power receiver may further include a magnetic sheet attached to a surface of the internal part, wherein the receiving coil includes a conductive pattern formed on a surface of the magnetic sheet.

The receiving coil may have a number of windings of an upper portion or a lower portion of the internal part greater than a central portion of the internal part.

The power circuit may include: a resonator including a resonance circuit connected to the receiving coil; a rectifier configured to rectify power provided from the resonator; and a converter configured to convert an output of the rectifier and provide the converted output to the wearable device.

According to another general aspect, a power supply apparatus includes: a battery configured to supply power; a receiving coil wound around an outer surface of the battery; and a power circuit configured to receive power from the receiving coil and provide the power to the battery.

The receiving coil may be wound in a length direction of the battery.

The power supply apparatus may further include a magnetic sheet attached to a surface of the battery, wherein a portion of the receiving coil may be wound around an outer surface of the magnetic sheet.

The power supply apparatus may further include a magnetic sheet attached to a surface of the battery, wherein the receiving coil may include a conductive pattern formed on a surface of the magnetic sheet.

The receiving coil may have a number of windings of an upper portion or a lower portion of the battery greater than that of a central portion of the battery.

The power circuit may include: a resonator including a resonance circuit connected to the receiving coil; a rectifier configured to rectify power provided from the resonator; and a converter configured to convert an output of the rectifying unit and provide the converted output to the battery.

According to another general aspect, a wearable electronic apparatus, includes: a substantially planar housing defining an interior receiving space; a substantially planar electronic component disposed within the interior receiving space in coplanar arrangement with the housing; and, a receiving coil disposed on the substantially planar electronic component in transverse relation to a plane defined by the housing.

The substantially planar electronic component may include a battery.

The receiving coil may be wrapped around the substantially planar electronic component.

An axis of the receiving coil may extend longitudinally in a direction substantially parallel to the plane defined by the housing.

The wearable electronic apparatus may further include: a magnetic sheet wrapped around the electronic component, the magnetic sheet configured to channel the magnetic flux around the electronic component.

The magnetic sheet may include a substrate and the receiving coil may be a conductive pattern formed on the substrate.

The magnetic sheet may include a substrate and the receiving coil may be a conductive pattern embedded in the substrate.

Other features and aspects will be apparent from the following detailed description, the drawings, and the claims.

### BRIEF DESCRIPTION OF THE DRAWINGS

The above and other aspects, features, and advantages of the present disclosure will be more clearly understood from the following detailed description taken in conjunction with the accompanying drawings, in which:

FIG. 1 is a diagram illustrating an example of a wireless power receiver used for a flat electronic device and a wireless power transmitter.

FIG. 2 is a diagram illustrating an example of a wireless power receiver used for a wearable device and a wireless power transmitter.

FIG. 3 is a block diagram illustrating a wireless power transmitter according to an embodiment.

FIG. 4 is a block diagram illustrating a wireless power receiver according to an embodiment.

FIG. 5 is a perspective view illustrating an example of a receiving coil according to an embodiment.

FIG. 6 is a front view illustrating a receiving coil according to an embodiment.

FIGS. 7A and 7B are cross-sectional views taken along direction I-I′ of the receiving coil of FIG. 6.

FIG. 8 is a front view illustrating a receiving coil according to another embodiment.

FIGS. 9A and 9B are cross-sectional views taken along direction I-I′ of the receiving coil of FIG. 8.

FIG. 10 is a front view illustrating a receiving coil according to another embodiment.

FIGS. 11A and 11B are cross-sectional views taken along direction I-I′ of the receiving coil of FIG. 10.

FIG. 12 is a diagram illustrating a receiving coil according to another embodiment. FIG. 13 is a diagram illustrating a receiving coil according to another embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments will be described with reference to schematic views. In the drawings, for example, due to manufacturing techniques and/or tolerances, modifications of the shape shown may be modified. Thus, embodiments should not be construed as being limited to the particular shapes of regions shown herein, but should, for example, be understood to include changes in shape resulting from manufacturing. The following embodiments may also be constituted by one or a combination thereof.

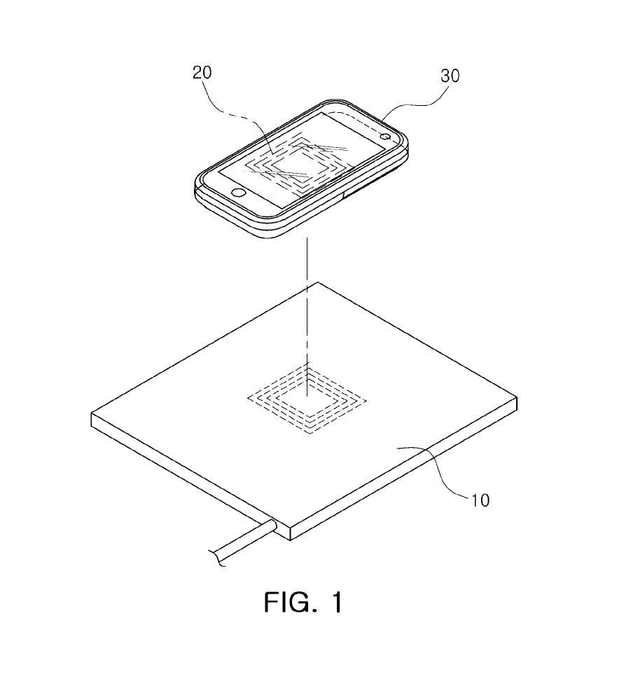

FIG. 1 is a diagram illustrating an example of a wireless power receiver used for a flat electronic device 30 and a wireless power transmitter 10.

In the example illustrated in FIG. 1, a wireless power receiver 20 is connected to an electronic device 30, such as a smartphone. The wireless power receiver 20 wirelessly receives power from a wireless power transmitter 10, and provides the power to the smartphone 30.

The wireless power receiver 20 may be positioned on a cover of the smartphone 30 or may be internally disposed. Thus, the wireless power receiver 20 may meet requirements for performing charging with the wireless power transmitter 10. That is, a receiving coil of the wireless power receiver 20 is set to be in parallel to a transmitting coil of the wireless power transmitter 10.

Thus, in the case of the illustrated example, the wireless power receiver 20 is formed on the cover of the smartphone 30, or the like, and receives power from the receiving coil wound in a planar shape.

Because a wireless power receiver 20 used for a wearable device needs to be miniaturized to the extent that it may be applied to the wearable device and a space for the receiving coil needs to also be secured in the miniaturized structure, the wireless power receiver has requirements different from those of the wireless power receiver of FIG. 1 described above.

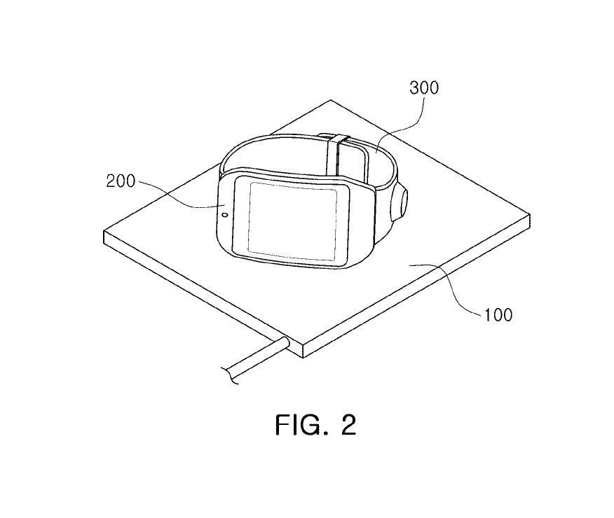

Hereinafter, a wireless power receiver according to various embodiments will be described with reference to FIGS. 2 through 13.

FIG. 2 is a diagram illustrating a wireless power receiver used for a wearable device and a wireless power transmitter.

In FIG. 2, as an example of a wearable device, a smart watch 300 is illustrated, but is merely illustrative. The wireless power receiver 200 may be used for various wearable devices which will be described in more detail below.

The wireless power receiver 200 is included in the smart watch 300.

When the smart watch 300 is positioned on the wireless power transmitter 100, the wireless power transmitter 100 and a body part of the smart watch 300 may be positioned to be perpendicular to each other. That is, as in the illustrated example, the wireless power transmitter 100 and the body part of the smart watch 300 are positioned so as not to be in parallel relation with each other.

In the case in which the smart watch 300 is positioned as in the illustrated example, if a coil of the wireless power receiver 200 is formed to be in parallel with the body part of the smart watch 300, the coil of the wireless power receiver 200 and a coil of the wireless power transmitter 100 will be perpendicular to each other. Magnetic coupling force between two coils which are perpendicular to each other is generally relatively weak. Thus, in this case, it may be impractical to perform substantially optimal wireless charging, or a time required to perform the charging may be increased.

Thus, the present disclosure provides various embodiments in which the wireless charging is stably performed even in an environment in which the wireless power receiver 200 is positioned to have a predetermined, non-parallel angle with the wireless power transmitter 100 as described above.

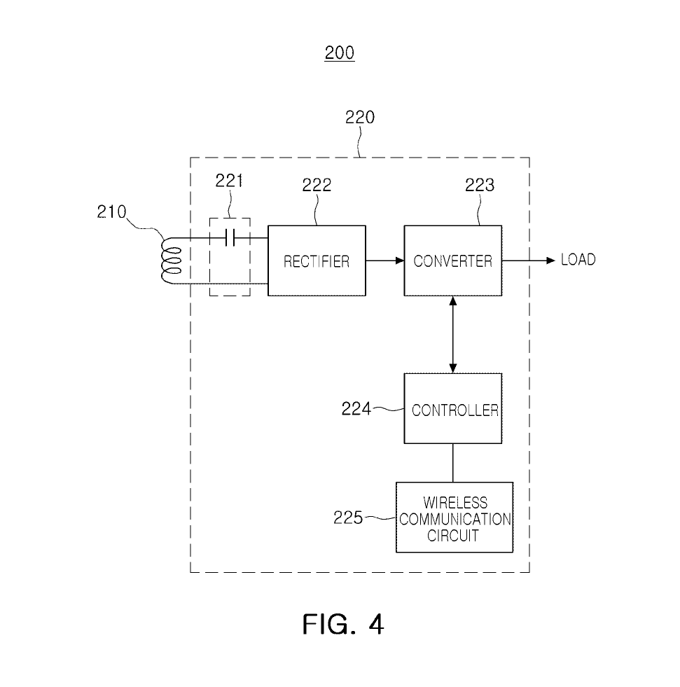

That is, according to various embodiments, the wireless charging is efficiently performed even in various wearable devices by forming a receiving coil of the wireless power receiver 200 such as in the embodiments illustrated in FIGS. 4 through 12 to be described below.

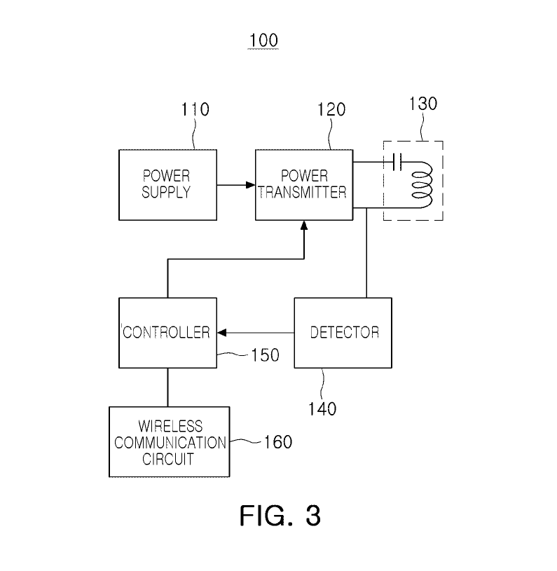

FIG. 3 is a block diagram illustrating a wireless power transmitter according to an embodiment.

Referring to FIG. 3, a wireless power transmitter 100 includes a power supply 110, a power transmitter 120, a resonator 130, a detector 140, and a controller 150. According to an embodiment, the wireless power transmitter 100 may further include a wireless communication circuit 160.

The power supply 110 supplies power to the respective components of the wireless power transmitter 100. For example, the power supply 110 receives and converts commercial alternating current power into a suitable number of direct current channels having various voltage levels and providing the converted direct current.

The power transmitter 120 is connected to a transmitting coil of the resonator 130 and provides current to the transmitting coil. For example, the power transmitter 120 includes an amplifying circuit including a plurality of switches. The amplifying circuit provides the current to the transmitting coil by switching operations for the plurality of switches.

The resonator 130 includes the transmitting coil. The transmitting coil is magnetically coupleable to the receiving coil of the wireless power receiver 200 and wirelessly transmits power thereto.

Here, the magnetic coupling made between the transmitting coil and the receiving coil is not limited to a particular manner. For example, the transmitting coil and the receiving coil may be magnetically coupled to each other in an electromagnetic inductive coupling manner. As another example, the transmitting coil and the receiving coil may also be magnetically coupled to each other in a magnetic resonance manner, or any other manner suitable for the transmission of wireless power.

The detector 140 detects a sensing voltage from a current flowing in the transmitting coil. The controller 150 determines a variation in impedance of the transmitting coil using a variation of the sensing voltage. The controller 150 determines whether or not the wireless power receiver 200 is adjacent to the wireless power transmitter 100 using the variation in the impedance.

FIG. 3 illustrates a case in which the detector 140 senses the current flowing in the transmitting coil, but this is merely illustrative. Thus, according to an embodiment, the detector 140 may be variously modified, such as detecting an input voltage of the power transmitter 120, and the like.

The controller 150 controls an operation of the power transmitter 120.

Controller 150 controls the power transmitter 120 to transmit a beacon signal (e.g., a long beacon signal or a short beacon signal). The controller 150 identifies whether or not the wireless power receiver 200 is in a state in which it may wirelessly receive the power, by receiving a response on the long beacon signal from the wireless communication circuit 160, or identifying the change in the impedance of the short beacon signal.

The controller 150 controls the power transmitter 120 to wirelessly transmit the power.

The controller 150 may include a processor or other suitable logic. Depending on the embodiments, the controller 150 further includes a memory. Here, the processor may include, for example, a central processing unit (CPU), a graphics processing unit (GPU), a microprocessor, an application specific integrated circuit (ASIC), field programmable gate arrays (FPGA), and the like, and may have a plurality of cores. The memory may be a volatile memory (e.g., RAM, or the like), a non-volatile memory (e.g., a ROM, a flash memory, or the like), or a combination thereof.

The wireless communication circuit 160 forms a short-range wireless communications line with the wireless power receiver 200. For example, the wireless communication circuit 160 may form the short-range wireless communications line with the wireless power receiver 200 in a BLUETOOTH(R), Near Field Communication (NFC), WiFi(R), visible light modulation, or other suitable manner.

FIG. 4 is a block diagram illustrating a wireless power receiver according to an embodiment.

A wireless power receiver 200 includes a receiving coil 210 and a power circuit 220 providing power received from the coil to the wearable device.

The power circuit 220 includes a resonator 221, a rectifier 222, a converter 223, and a controller 224. Depending on the embodiments, the power circuit 220 further includes a wireless communication circuit 225.

The resonator 221 includes a resonance circuit connected to the receiving coil 210. The resonator 221 is magnetically coupleable to the resonator 130 of the wireless power transmitter to wirelessly receive the power.

The power received by the resonator 221 is rectified by the rectifier 222, and converted by the converter 223 to be provided to the wearable device, such as, to a battery of the wearable device.

The controller 224 controls an operation of the rectifier 222 or the converter 223.

The controller 224 may include a processor or other suitable logic.

Depending on the embodiments, the controller 224 may further include a memory. Here, the processor may include, for example, a central processing unit (CPU), a graphics processing unit (GPU), a microprocessor, an application specific integrated circuit (ASIC), field programmable gate arrays (FPGA), and the like, and may have a plurality of cores. The memory may be a volatile memory (e.g., RAM, or the like), a non-volatile memory (e.g., a ROM, a flash memory, or the like), or a combination thereof.

Depending on the embodiment, the controller 224 may also be implemented as a portion of a larger controller, such as in a system on chip (SOC) along with a controller of the wearable device.

In the case of an embodiment including the wireless communication circuit 250, the controller 224 performs communications for the power transmission with the wireless power transmitter 100 using the wireless communication circuit 250.

In a case in which the transmitting coil and the receiving coil are disposed substantially in parallel relation with each other, efficiency of a magnetic coupling between the transmitting coil and the receiving coil may be at the highest level. As a tilt angle is increased, efficiency of the magnetic coupling is generally decreased. Thus, since a wearable device according to the related art has a large angle formed by the receiving coil and the transmitting coil, there is a problem in that efficiency of the magnetic coupling is low.

Hereinafter, various embodiments of a receiving coil which may provide an efficient magnetic coupling even in a wearable device will be described.

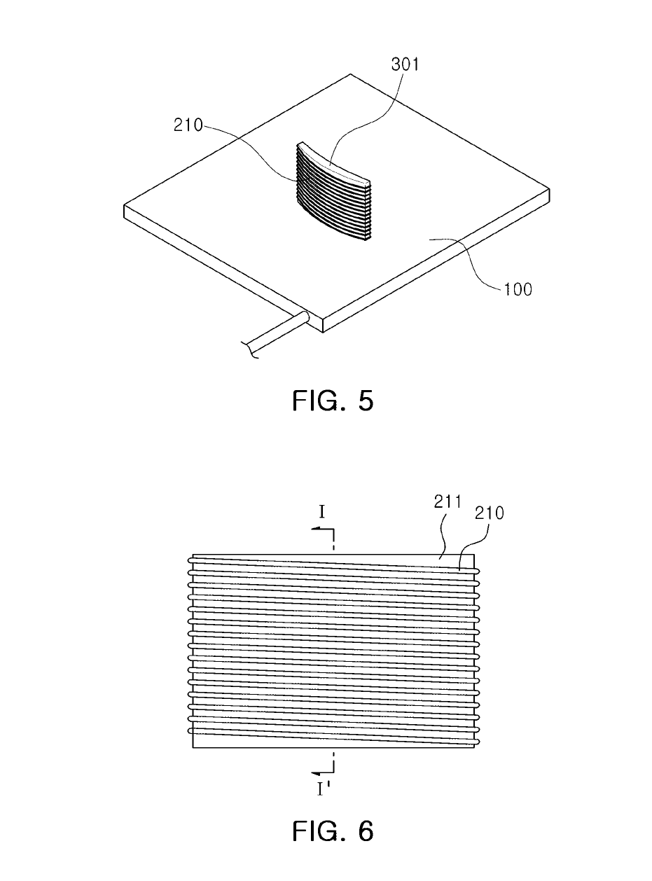

FIG. 5 is a perspective view illustrating an example of a receiving coil according to an embodiment.

Referring to FIG. 5, a receiving coil 210 is wound around an outer surface of the internal part 301 of the wearable device.

The internal part 301 is a part included in a body of the wearable device. According to an embodiment, the internal part 301 may be a battery supplying power to the wearable device.

The internal part 301 may have a predetermined thickness. As a result, since the receiving coil 210 wound around the outer surface of the internal part 301 is wound in an oval, trapezoidal, or a circular shape, depending on the part, the receiving coil 210 is smoothly and magnetically coupled to the transmitting coil of the wireless power transmitter 100.

According to an embodiment, the internal part 301 is a polyhedron having a length in one direction longer than that in the other direction. Here, one direction is referred to as a length direction. The receiving coil 210 is wound around the outer surface of the internal part 301 in the length direction of the internal part 301.

In the case of the illustrated example, the internal part 301 is a battery of a curved hexahedral shape in which a horizontal direction is the length direction. The receiving coil 210 is wound in the length direction of the internal part 301. Thus, the receiving coil 210 and the transmitting coil in the wireless power transmitter 100 are positioned to be parallel with each other or at approximately a horizontal angle.

The wearable device may be laid, for example, in the length direction as illustrated in FIG. 2 when being positioned on the wireless power transmitter 100, in the case in which the internal part 301 is the polyhedron having the length in one direction longer than that in the other direction. That is, in the case in which the internal part 301 is the polyhedron having the length in one direction longer than that in the other direction, the wearable device may also have a shape of which a length in one direction is longer than that in the other direction. Thus, since standing the wearable device is unstable as long as the wearable device does not have a separate structure, the wearable device may be laid in the length direction.

Thus, the receiving coil 210 wound in the length direction of the internal part 301 and the transmitting coil in the wireless power transmitter 100 may be positioned to be parallel with each other or at approximately a horizontal angle.

According to an embodiment, the internal part 301 may be a polyhedron of which a first direction and a second direction have lengths corresponding to each other. In the embodiment described above, the receiving coil 210 is wound around the outer surface of the internal part 301 in the first direction of the internal part 301. Here, the first direction may be determined depending on an entire shape or a length of the wearable device.

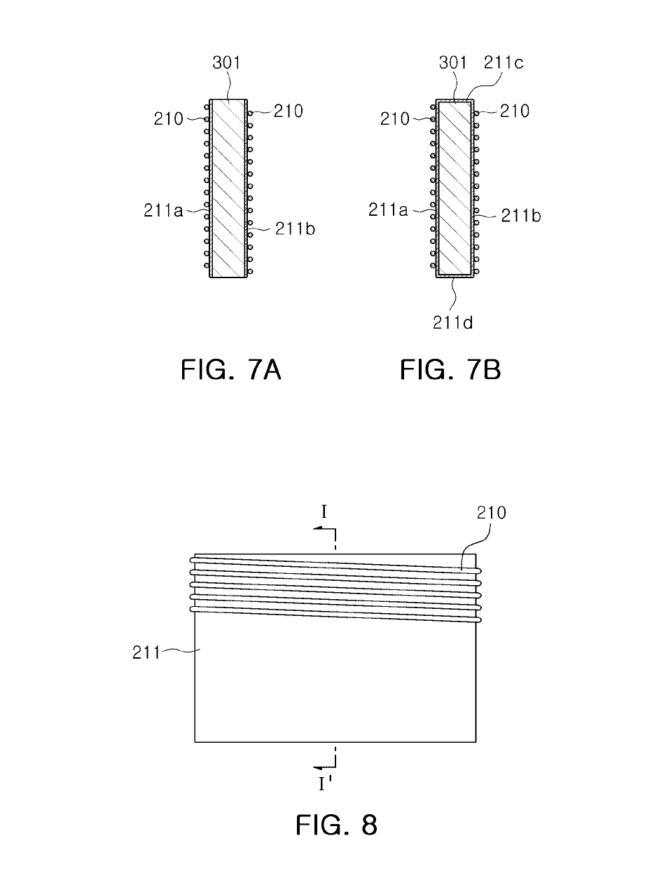

FIG. 6 is a front view illustrating a receiving coil according to an embodiment, and FIGS. 7A and 7B are cross-sectional views taken along direction I-I′ of the receiving coil of FIG. 6.

As illustrated in FIGS. 6 through 7B, the wireless power receiver further includes a magnetic sheet 211.

The magnetic sheet 211 is attached to a surface of the internal part 301. The receiving coil 210 is wound around an outer surface of the magnetic sheet 211.

The magnetic sheet 211 may be formed of a material having a predetermined magnetism. For example, the magnetic sheet 211 may be formed of a resin material including metal powders. As another example, the magnetic sheet 211 may be formed of a ferrite sheet (which may include NiZnCu/MnZn based metal), a sendust based metal, a permalloy based metal, an amorphous based magnetic body, or a combination thereof.

FIG. 7A illustrates an embodiment in which magnetic sheets 211a and 211b are attached to front and rear surfaces, respectively, of the internal part 301, and FIG. 7B illustrates an example embodiment in which the magnetic sheets 211a, 211b, 211c and 211d are attached to the front and rear surfaces of the internal part 301, upper and lower surfaces, and both side surfaces (not illustrated).

The illustrated magnetic sheets 211 (211a to 211d) serve as passages through which a magnetic field formed by the receiving coil 210 flows. Thus, even though the internal part 301 is an object having insulation such as the battery, or the like, the magnetic field formed by the receiving coil 210 may flow through the magnetic sheets 211 (211a to 211d).

In the illustrated example, although the case in which the receiving coil 210 is wound around the outer surface of the magnetic sheet 211 is illustrated, this is merely illustrative. That is, the receiving coil 210 may be any suitable conductive material. For example, the magnetic sheet 211 may be configured by a predetermined substrate such as a printed circuit board (PCB), flexible PCB, or the like, and the receiving coil 210 may be formed in a conductive pattern formed on or in the substrate.

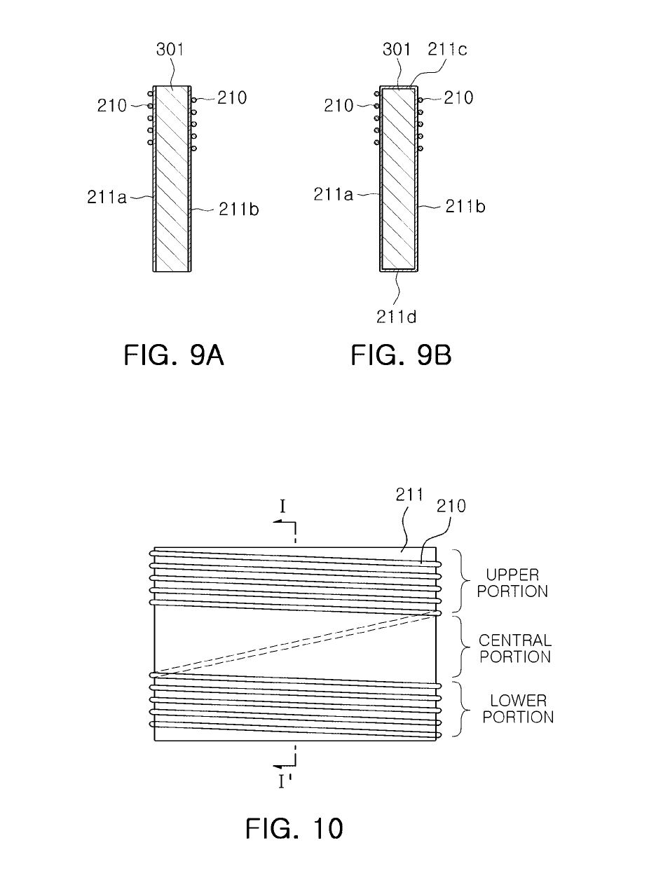

FIG. 8 is a front view illustrating a receiving coil according to another example embodiment, and FIGS. 9A and 9B are cross-sectional views taken along direction I-I′ of the receiving coil of FIG. 8.

As illustrated in FIGS. 8 through 9B, the magnetic sheet 211 is attached to the outer surface of the internal part 301. The receiving coil 210 is wound around the outer surface of the magnetic sheet 211 on one upper side surface of the internal part 301.

The present embodiment is applied to a case in which the coil is not wound around the other side surface of the internal part 301 due to other considerations, such as a shape or form of the wearable device.

FIG. 9A illustrates an embodiment in which magnetic sheets 211a and 211b are attached to front and rear surfaces, respectively, of the internal part 301, and FIG. 9B illustrates an embodiment in which the magnetic sheets 211a, 211b, 211c and 211d are attached to the front and rear surfaces of the internal part 301, upper and lower surfaces, and both side surfaces (not illustrated).

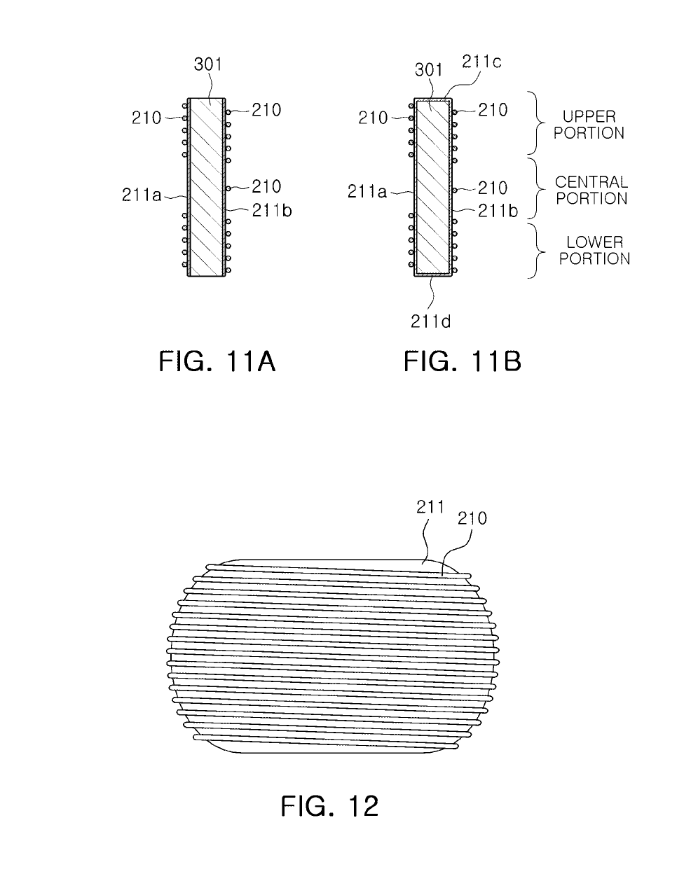

FIG. 10 is a front view illustrating a receiving coil according to another embodiment, and FIGS. 11A and 11B are cross-sectional views taken along direction I-I′ of the receiving coil of FIG. 10.

As illustrated in FIGS. 10 through 11B, the magnetic sheet 211 is attached to the outer surface of the internal part 301, and the receiving coil 210 is wound around both side surfaces of the internal part 301 on the outer surface of the magnetic sheet 211.

In the illustrated example, the receiving coil has a number of windings of an upper portion and/or a lower portion of the internal part 301 greater than that of a central portion of the internal part. In this example, since a volume of the receiving coil 210 is relatively small in the central portion of the internal part 301, a corresponding space may be utilized. For example, a circuit may be disposed in the central portion. Thus, the wearable device may be formed to have a slimmer shape.

FIG. 11A illustrates an embodiment in which magnetic sheets 211a and 211b are attached to front and rear surfaces, respectively, of the internal part 301, and FIG. 11B illustrates an example embodiment in which the magnetic sheets 211a, 211b, 211c and 211d are attached to the front and rear surfaces of the internal part 301, upper and lower surfaces, and both side surfaces (not illustrated).

In the embodiments illustrated in FIGS. 4 through 11, although the internal part 301 is illustrated in a hexahedral shape having a curved surface, the internal part 301 may be formed in various shapes as described above.

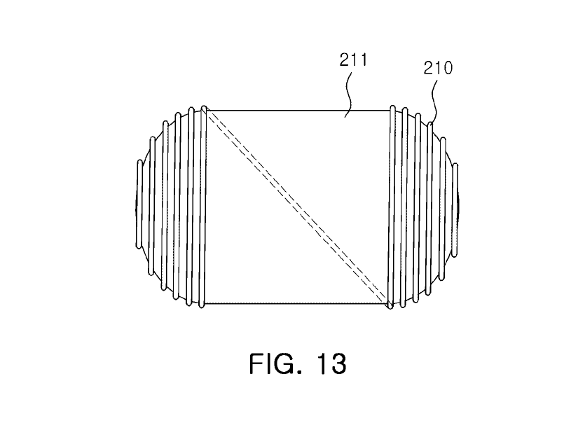

FIGS. 12 and 13, which are diagrams illustrating a receiving coil according to another embodiment, illustrate examples in which the internal part is formed in an oval shape.

As illustrated in FIG. 12, in the case in which the internal part is formed in the oval shape, the magnetic sheet 211 is attached to the outer surface of the internal part, and the receiving coil 210 is wound around the magnetic sheet 211.

Further, as described above, a winding direction of the receiving coil 210 may be differently determined depending on an entire shape or a length of the wearable device.

As illustrated in FIG. 13, the receiving coil 210 is wound around circular arcs of the oval shape. A case in which the receiving coil 210 is wound as illustrated in the present embodiment may be applied to a wearable device which is generally stood in a length direction thereof.

As described in FIGS. 4 through 13, according to various embodiments, the receiving coil 210 and the transmitting coil of the wireless power transmitter 100 may be disposed substantially in parallel relation to each other, or may be disposed at an angle within a predetermine angle from a horizontal surface.

Thus, magnetic coupling force between the receiving coil 210 and the transmitting coil of the wireless power transmitter 100 may be enhanced. As a result, the wearable device may efficiently and wirelessly transmit or receive the power even with non-ideal geometries and internal arrangements. Further, since the receiving coil 210 and the transmitting coil of the wireless power transmitter 100 may have the stronger magnetic coupling force, a degree of freedom for a charging distance may also be increased.

Although the wireless power receiver is described as an apparatus distinct from the wearable device in the above-mentioned description, the wireless power receiver may be implemented as one configuration of the wearable device according to the example embodiments.

According to an embodiment, the wireless power receiver may be one configuration of a power supply apparatus of the wearable device. According to the embodiment described above, the power supply apparatus includes an internal part, such as a battery, in the wearable device supplying the power to the wearable device, a receiving coil wound around the outside of the battery, and a power circuit unit providing power received from the receiving coil to the battery. Further, the various embodiments described with reference to FIGS. 4 through 13 may also be applied to the above-mentioned wireless power receiver.

The apparatuses, units, modules, devices, and other components (e.g., the power supply 100, power transmitter 120, controller 150, resonator 130, detector 140, wireless communication circuit 160, resonator 221, converter 223, controller 224, and the like) illustrated in FIGS. 1 to 13 that perform the operations described herein are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described herein may be performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the above descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

As a non-exhaustive example only, a wearable device as described herein may be a mobile device (such as a ring, a watch, a pair of glasses, a bracelet, an ankle bracelet, a belt, a necklace, an earring, a headband, a helmet, or a device embedded in clothing). In one example, a wearable device is a device that is designed to be mountable directly on the body of the user, such as a pair of glasses or a bracelet.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

As set forth above, according to the above embodiments, the wireless power receiver may efficiently perform the wireless charging even in the wearable device.

While various embodiments have been shown and described above, it will be apparent to those skilled in the art that modifications and variations could be made without departing from the scope of the present invention as defined by the appended claims.

What is claimed is:

1. A wireless power receiver in a wearable device, the wireless power receiver comprising:
a receiving coil wound around an internal part; and
a power circuit configured to receive power from the receiving coil and provide the power to the wearable device.

2. The wireless power receiver of claim 1, wherein the receiving coil is wound in a length direction around the internal part.

3. The wireless power receiver of claim 1, further comprising a magnetic sheet attached to a surface of the internal part,
wherein a portion of the receiving coil is wound around an outer surface of the magnetic sheet.

4. The wireless power receiver of claim 1, further comprising a magnetic sheet attached to a surface of the internal part,
wherein the receiving coil includes a conductive pattern formed on a surface of the magnetic sheet.

5. The wireless power receiver of claim 1, wherein the receiving coil has a number of windings of an upper portion or a lower portion of the internal part greater than a central portion of the internal part.

6. The wireless power receiver of claim 1, wherein the power circuit comprises:
a resonator including a resonance circuit connected to the receiving coil;
a rectifier configured to rectify power provided from the resonator; and
a converter configured to convert an output of the rectifier and provide the converted output to the wearable device.

7. A power supply apparatus comprising:
a battery configured to supply power;
a receiving coil wound around an outer surface of the battery; and
a power circuit configured to receive power from the receiving coil and provide the power to the battery.

8. The power supply apparatus of claim 7, wherein the receiving coil is wound in a length direction of the battery.

9. The power supply apparatus of claim 7, further comprising a magnetic sheet attached to a surface of the battery,
wherein a portion of the receiving coil is wound around an outer surface of the magnetic sheet.

10. The power supply apparatus of claim 7, further comprising a magnetic sheet attached to a surface of the battery,
wherein the receiving coil includes a conductive pattern formed on a surface of the magnetic sheet.

11. The power supply apparatus of claim 7, wherein the receiving coil has a number of windings of an upper portion or a lower portion of the battery greater than that of a central portion of the battery.

12. The power supply apparatus of claim 7, wherein the power circuit comprises:
a resonator including a resonance circuit connected to the receiving coil;
a rectifier configured to rectify power provided from the resonator; and
a converter configured to convert an output of the rectifying unit and provide the converted output to the battery.

13. A wearable electronic apparatus, comprising:
a substantially planar housing defining an interior receiving space;
a substantially planar electronic component disposed within the interior receiving space in coplanar arrangement with the housing; and,
a receiving coil disposed on the substantially planar electronic component in transverse relation to a plane defined by the housing.

14. The wearable electronic apparatus of claim 13, wherein the substantially planar electronic component comprises a battery.

15. The wearable electronic apparatus of claim 13, wherein the receiving coil is wrapped around the substantially planar electronic component.

16. The wearable electronic apparatus of claim 13, wherein an axis of the receiving coil extends longitudinally in a direction substantially parallel to the plane defined by the housing.

17. The wearable electronic apparatus of claim 13 further comprising:
a magnetic sheet wrapped around the electronic component, the magnetic sheet configured to channel the magnetic flux around the electronic component.

18. The wearable electronic apparatus of claim 17, wherein the magnetic sheet comprises a substrate and the receiving coil comprises a conductive pattern formed on the substrate.

19. The wearable electronic apparatus of claim 17, wherein the magnetic sheet comprises a substrate and the receiving coil comprises a conductive pattern embedded in the substrate.
